(19) United States
(12) Patent Application Publication
(10) Pub. No.: US 2021/0246243 A1
(43) Pub. Date: Aug. 12, 2021

(54) THERMOPLASTIC COMPOSITION COMPRISING A MICROWAVE-DEPOLYMERISATION SENSITISING COMPOUND

(71) Applicant: Arkema France, Colombes (FR)

(72) Inventor: Jean-Luc DUBOIS, Millery (FR)

(21) Appl. No.: 17/049,681

(22) PCT Filed: Apr. 26, 2019
(86) PCT No.: PCT/FR2019/050992

§ 371 Date: Oct. 22, 2020

(30) Foreign Application Priority Data
Apr. 27, 2018 (FR) 1853716

(51) Int. Cl. C08F 220/18; C08J 11/10; C08K 3/01; C08J 5/12; B01J 19/12

(52) U.S. Cl. CPC C08F 220/18; C08J 11/10; C08J 2333/12; C08J 5/12; B01J 19/126; C08K 3/01

(57) ABSTRACT

The invention relates to a thermoplastic composition comprising the following: at least one thermoplastic polymer precursor, and at least one microwave depolymerization sensitizer compound. The invention likewise relates to a method for recycling an article, comprising:
placing the article in a reactor, and
applying microwave radiation at a given frequency to the article placed in the reactor.

The present invention pertains generally to thermoplastic polymers and more particularly to a composition for forming thermoplastic polymers that comprises a compound for sensitization to depolymerization by microwave radiation, and to articles made with this composition. The invention finds applications in a variety of industrial sectors such as construction, transport, electronics, in the manufacture of photovoltaics, in lighting and signs, and in sanitary ware.

### PRIOR ART

In 2017, millions of metric tons of thermoplastics were produced on a worldwide basis. Accordingly, the production and recycling of thermoplastics appear readily to be major factors from an environmental and economic standpoint. Among the conventional methods for recycling plastics, thermal pyrolysis and mechanical recycling are those most often employed.

The thermal pyrolysis of thermoplastics involves placing the thermoplastic item for treatment in a suitable chamber and then heating the chamber so that the heat is transferred to the thermoplastic item. It allows the treatment of thermoplastic wastes, and results generally in sooty residues, oil, and gases, which cannot be reused in the production of thermoplastic polymer matrix. Moreover, thermal pyrolysis is difficult to adapt for large-scale use, owing to problems of waste storage and the associated costs, or else owing to limitations of heat transfer (to the polymer for treatment). Furthermore, thermal pyrolysis involves a special facility with an appropriate heating device, which may be dangerous to manage in light of the fire risks in particular. A further factor is that this type of facility experiences fouling problems which are amplified in the event of large-scale use, so implying a large maintenance cost.

Mechanical recycling involves sorting, washing, and grinding the wastes in order to obtain flakes, which are in turn washed, rinsed, drained, dried, and screened. However, the ground material obtained is generally not of high quality and is rarely reused alone in plastics technology. Moreover, this method is long and difficult to implement, especially when applied to plastic films, which are light and awkward to recover. Moreover, wastes based on plastics are generally composed of a number of types of associated materials. Besides thermoplastics, these wastes may contain other types of plastic having different properties, or fibers, for example. In that event, the steps of sorting and preparing the wastes become much more complicated. Furthermore, the recovery of sufficiently pure materials at the exit on the sorting center, to be reused, is difficult and complicated.

Generally speaking, mixtures of plastics are difficult to recycle, and the products obtained after thermal or mechanical treatment are generally destined for applications where material performance is less exacting.

Furthermore, these recycling methods are aimed at the treatment of plastic wastes, but do not allow a polymer to be depolymerized, i.e., decomposed. Depolymerization or decomposition can lead in particular to recovery of the base monomers of the treated polymer.

Depolymerization using a bed of molten lead, however, is known, especially in the case of poly(methyl methacrylate) (PMMA). In this method, the thermoplastics are ground and are decomposed in a bed of molten lead taken to a temperature of more than 400° C. A process of this kind, however, has a number of drawbacks. The lead is highly toxic to humans and to the environment, and using it is therefore strongly advised against. Furthermore, the reactor containing the bath experiences fouling problems which also affect the bed of lead itself. Cleaning a device of this kind is tedious, and gives rise to toxic byproducts containing lead. The treatment of lead-polluted wastes is therefore a prospect. Moreover, restarting the heating system and remelting the lead are expensive and energy-consuming operations.

Document WO2010/070165 describes a process for obtaining polymer foam and for recycling thermally stable foams. These foams are made from PE or EVA or mixtures thereof.

Document U.S. Pat. No. 5,338,611 describes the manufacture of articles made of bulky materials, by welding. This is done by placing a strip of a miscible thermoplastic material, containing a microwave-sensitive compound, in the welding zone between the two substrates for welding.

Document US 2009/286013 describes a process and a polymer material which facilitates the rapid and volumetric heating of the polymer, using microwave energy, for product assemblies.

Document WO02/072333 describes a polymer composition which is curable with moisture or with microwaves, and which is coextruded, calandered or comolded with a thermoplastic polymer.

Document JP2016112835 describes a thermoplastic composition containing ferrites for heating an item in a mold to a certain temperature.

Document JP2014180778 describes a method for uniform welding of two polymers. A welding material, composed of the same thermoplastic resin as the base material for welding, comprises particles which generate heat under microwaves.

It is therefore apparent that the existing techniques do not enable effective recycling of thermoplastic products.

### TECHNICAL PROBLEM

The invention aims to do away with, or at least mitigate, some or all of the drawbacks identified above in the prior art.

The invention therefore provides a simple and effective solution for extracting value from thermoplastic wastes and/or for recovering the monomers with a view to reusing them in the manufacture of thermoplastic articles. The invention also enables specific depolymerization of polymer, while allowing energy to be used economically. The invention therefore integrates into a durable development context.

### BRIEF DESCRIPTION OF THE INVENTION

To this end, a first aspect of the invention provides a thermoplastic composition comprising at least one thermoplastic polymer precursor and at least one microwave depolymerization sensitizer compound.

By virtue of the thermoplastic composition of the invention, it is possible to produce articles comprising a thermoplastic polymer matrix, formed from the polymer precursor contained in the thermoplastic composition, for which treatment and recycling are made easier. In particular, thermoplastic articles made on the basis of the composition containing the sensitizer are more receptive to microwave radiation and are more easily recycled.

The thermoplastic polymer precursor forms the thermoplastic polymer matrix or a part of the thermoplastic polymer matrix after polymerization. The thermoplastic polymer precursor contains, for example, at least one polymerizable monomer, which after polymerization is comprised in the thermoplastic composition.

According to other, optional characteristics of the composition:
the at least one thermoplastic polymer precursor is selected from compounds containing acrylate, carbonate, ester, styrene, sulfone or vinyl acetate groups or a mixture thereof.
the at least one thermoplastic polymer precursor is a liquid (meth)acrylic composition comprising a (meth)acrylic monomer or a mixture of (meth)acrylic monomers, a (meth)acrylic polymer, and at least one radical initiator.
the depolymerization sensitizer compound has a dielectric loss factor of greater than or equal to 0.1 at a frequency of between 900 MHz and 2500 MHz and at 25° C., and preferably of greater than or equal to 0.1 at a frequency of 2.45 GHz and at 25° C. This allows the sensitizer compound to absorb the microwave energy more rapidly than the thermoplastic polymers, and then to dissipate this energy in the form of heat, so bringing about more rapid heating of said polymers.
the depolymerization sensitizer compound has a dielectric constant of greater than or equal to 5 at a frequency of between 900 MHz and 2500 MHz and at 25° C., and preferably of greater than or equal to 5 at a frequency of 2.45 GHz and at 25° C. This allows rapid heating of the material.
the depolymerization sensitizer compound has a loss tangent of greater than or equal to 10⁻⁴ at a frequency of between 900 MHz and 2500 MHz and at 25° C., and preferably of greater than or equal to 10⁻⁴ at a frequency of 2.45 GHz and at 25° C.
the depolymerization sensitizer compound is present in an amount of from 0.1% to 50% by weight of the thermoplastic composition.
the depolymerization sensitizer compound is selected from: SiC, TiO₂, ZrO₂, BaTiO₃, SrTiO₃, MgTiO₃, CaTiO₃, LaAlO₃, ferrites, basalt, marble, and mixtures thereof. The depolymerization sensitizer compound may also be selected from: ferrites, barium titanate, strontium titanate, calcium titanate, magnesium titanate, and mixtures thereof. Sensitizer compounds of these kinds allow more rapid heating of the polymeric matrix formed from the at least one thermoplastic polymer precursor
the depolymerization sensitizer compound is present only in certain places in the thermoplastic composition after polymerization: the depolymerization sensitizer compound is present in less than 90% by volume of the thermoplastic composition
the depolymerization sensitizer compound is present in the thermoplastic composition after polymerization in at least 10% by volume of the thermoplastic composition.

In a second aspect, the invention relates to a method for manufacturing an article, comprising a step of preparing a thermoplastic composition of the invention, and a step of forming said article from said composition. This method may also comprise a step of impregnating a reinforcement with said composition. A method of this kind allows the thermoplastic articles made from the thermoplastic composition to be more receptive to the microwave radiation and to be more easily recycled.

According to one optional characteristic of the method, the forming step is selected from the group consisting of the following: extrusion, coextrusion, thermoforming, injection molding, compression molding, extrusion film, blow molding, multimaterial injection molding, or sheet casting. Therefore, from the point of its conception, the article formed from the thermoplastic composition has the advantage of being recyclable rapidly and therefore with reduced energy cost.

In a third aspect, the invention also provides an article comprising a thermoplastic matrix formed from the thermoplastic composition according to the first aspect. Accordingly, this article comprises more particularly a thermoplastic matrix formed from at least one thermoplastic polymer precursor. The thermoplastic matrix is combined with at least one microwave depolymerization sensitizer compound. An article of this kind makes it possible, for example, to promote recycling and therefore to reduce the costs and the environmental impact.

In a fourth aspect, the invention also provides a method for recycling an article comprising a thermoplastic matrix formed form a thermoplastic composition comprising at least one microwave depolymerization sensitizer compound, said method comprising the following steps:
placing the article in a reactor, and
subjecting the article placed in the reactor to microwave radiation at a frequency of between 10 MHz and 5.8 GHz, so as to initiate depolymerization by absorption of microwaves by said microwave sensitizer compound, and converting at least part of the article into at least one base monomer of said thermoplastic matrix.

According to other, optional characteristics of the article:
the thermoplastic matrix of the invention is a matrix based on the following: acrylic homo- and copolymers, polyalkyl (meth)acrylates, poly(methyl methacrylate), polycarbonates, polyesters, polystyrene, polyetherimide, polysulfone, poly(phenylene sulfide), poly(vinyl acetate), or a mixture of two or more of these polymers. These polymers lend themselves particularly to industry treatment and recycling processes and they allow a certain malleability, thereby facilitating their shaping by application of heat and pressure. The thermoplastics regain their initial stiffness after cooling, and do so without the material being thermally degraded.
the thermoplastic matrix comprises a thermoplastic polymer having a dielectric loss factor of less than or equal to 0.1, as measured at 2450 MHz and 25° C., more preferably less than or equal to 0.05, and more preferably still less than or equal to 0.02. With these kinds of dielectric loss factor values, the thermoplastic polymer and, more broadly, the thermoplastic matrix, in the absence of sensitizer compound, do not absorb microwaves very much. Therefore, when it is additivized with at least one microwave depolymerization sensitizer compound, it can then be depolymerized more rapidly with a reduced energy consumption.
the thermoplastic matrix comprises poly(methyl methacrylate). The presence of poly(methyl methacrylate) in the thermoplastic matrix enables the matrix to be dissolved in the monomer or the matrix to be depolymerized into methyl methacrylate (MAM) and so makes the article particularly suitable for recycling according to the invention.
the article is a composite polymer part. This allows selective depolymerization when it is used in an assembly with parts manufactured from the composition of the invention.
the article comprises a plurality of portions of polymeric compounds and it comprises at least one sensitizer compound only in part of the portions of polymeric compounds. On depolymerization by microwaves, this allows the portion comprising the sensitizer compound to be heated selectively and rapidly. Accordingly, the portion comprising the sensitizer compound is able to reach a melted and/or liquid state, whereas the portion or portions without sensitizer (e.g., reinforcement, glue, foam) do not heat up or heat up too much less of an extent. The separation of the melted and/or liquid thermoplastic material from the unmelted portion is then made easier. The wastes can therefore be treated more effectively, by virtue of the invention.
the article comprises a plurality of portions of polymeric compounds and it comprises at least one sensitizer compound in the entirety of the portions of polymeric compounds. An article of this kind has the advantage of being recyclable rapidly and at reduced energy cost, while allowing improved acquisition of heat and improved distribution of heat, owing to the presence of the sensitizer present in the article from its manufacture.

The invention further provides a method for recycling an article according to the invention, comprising:
placing the article in a reactor, and
subjecting the article placed in the reactor to microwave radiation at a frequency of between 100 MHz and 1 GHz, preferably between 900 MHz and 2500 MHz.

This method allows the recycling to be made easier. Microwave radiation allows rapid and localized heating in the zones containing the sensitizer, resulting in liquefaction, gasification or depolymerization rapidly and in low energy consumption. In contrast to article treatment based on microwave radiation where the thermoplastic articles collectively would be mixed a posteriori with a sensitizer compound, the use here of a sensitizer which is already integrated enables a reduction in the consumption of energy, the targeting of the parts of the article most amenable to recycling, and the partial recycling of articles. As a result, moreover, it is possible to treat one type of polymer specifically so as to recover only one type of monomer. For example, in a PMMA/polyurethane foam composite, if the sensitizer is in the PMMA, it is then possible to carry out partial depolymerization of the PMMA, without the heat attacking the polyurethane and giving rise to impurities. If the sensitizer is mixed a posteriori, it is no longer possible to place it in contact with the PMMA only.

According to other, optional characteristics of the recycling method:
It further comprises a step of reducing the weight of the article. The reason is that, under the effect of the radiation, the sensitizer compound will heat up and increase the temperature of the thermoplastic polymer, so giving rise to a reduction in the weight of the article following liquefaction, gasification or depolymerization of at least part of the article.
It further comprises the following steps:
   initiating the depolymerization by absorption of microwaves by a microwave sensitizer, and
   converting at least part of the article into at least one monomer of the thermoplastic matrix.

This allows rapid depolymerization and little generation of contaminants.
The microwave radiation is applied until the weight of the article is reduced by at least 10%, preferably at least 20%.
It comprises a prior step of applying microwave radiation and of measuring the temperature of the articles so as to determine if the article is an article for recycling. Such a step allows only articles comprising the sensitizer compound to be treated, for example, if it is coupled with a means for sorting the articles. The reason is that, thanks to the presence of a sensitizer, it is possible to heat the mixture of polymers only very rapidly, to raise the temperature thereof only slightly. When the sorting machine is equipped with a thermal camera, it then becomes possible to sort out the particles with a high sensitizer content. When the optical sorting machine is also equipped with infrared or Raman spectroscopic technologies, it is also possible to sort the mixture of plastics. The advantage provided by the presence of sensitizer is, for example, that of enabling the sorting of black products, which are not recognized by infrared spectroscopy.

Other characteristics and advantages of the invention will become apparent more on a reading of the description hereinafter. This description is purely illustrative and should be read in association with the attached drawings, in which:

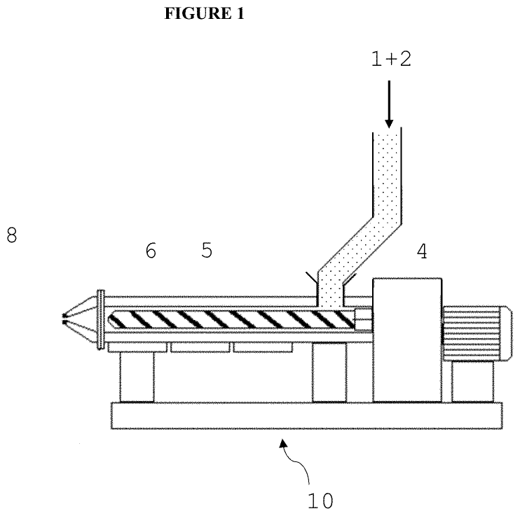

FIG. 1 is a schematic representation of an example of preparing a thermoplastic composition comprising a microwave polymerization sensitizer;

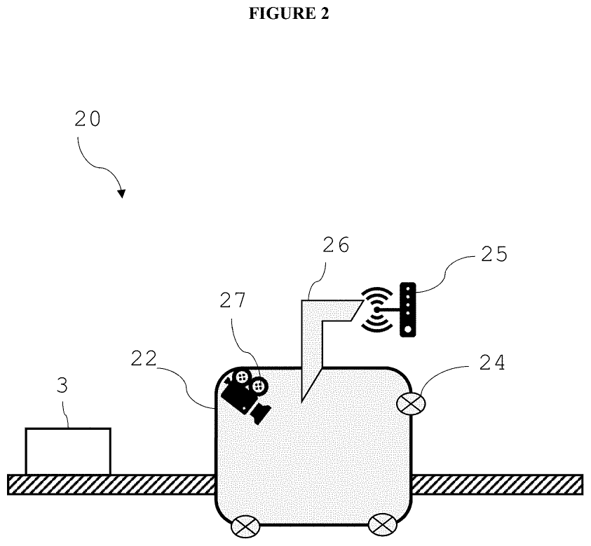

FIG. 2 is a system for implementing the depolymerization method, according to one embodiment; and

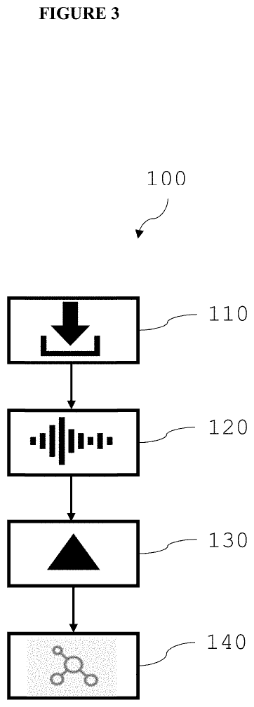

FIG. 3 shows a step diagram of one embodiment of the depolymerization method.

### DESCRIPTION OF THE INVENTION

In the rest of the description, “polymer” either refers to a copolymer or to a homopolymer. The term “copolymer” means a polymer grouping together several different monomer units and the term “homopolymer” means a polymer grouping together identical monomer units.

The term “matrix” means a solid polymer material which can act as a binder, and which relates to any type of compounds, polymers, oligomers, copolymers or block copolymers, acrylic and methacrylic. The thermoplastic matrix is a continuous phase.

For the purposes of the invention, the term “radical initiator”, denotes a compound that can start/initiate the polymerization of a monomer or monomers.

For the purposes of the invention, the term “polymerization” denotes the process of conversion of a monomer or of a blend of monomers into a polymer.

For the purposes of the invention, the term “monomer” denotes a molecule which can undergo a polymerization.

For the purposes of the invention, the expression “polymer composite” denotes a multicomponent material comprising at least two immiscible components, in which at least one component is a polymer and the other component may be, for example, a reinforcement or a pulverulent filler.

For the purposes of the invention, the term “reinforcement” means a solid material which is not depolymerizable or gasifiable and which therefore remains at the end of treatment, such as a fibrous reinforcement or a mineral filler.

For the purposes of the invention, the term “fibrous reinforcement” means a plurality of fibers, unidirectional rovings or a continuous filament mat, fabrics, felts or nonwovens which may be in the form of strips, webs, braids, strands or parts.

For the purposes of the invention, the term “mineral filler” means any inert substances which are mineral in nature that can be added to a thermoplastic polymer so as to enhance the mechanical properties of the composite article or to reduce its cost price. The mineral fillers may be, for example, quartz, marble, or silica.

For the purposes of the invention, the term “thermoplastic polymer” means a polymer that is generally solid at room temperature, which may be crystalline, semicrystalline or amorphous, and which softens during an increase in temperature, in particular after passing its glass transition temperature (Tg) and flows at higher temperature and that may exhibit obvious melting on passing its “melting” point (Tm) (when it is semicrystalline) and which becomes solid again during a reduction in temperature below its melting point and below its glass transition temperature. This also applies for thermoplastic polymers which are slightly crosslinked by the presence of polyfunctional monomers or oligomers present in a percentage by mass of preferably less than 10 wt %, preferably less than 5 wt % and more preferably less than 2 wt %, and which can be thermoformed when they are heated above the softening temperature. Examples of thermoplastics are the following, for example: low-density polyethylene (LDPE), used in particular for producing plastic bags or for automotive construction; polyethylene terephthalate (PET), polyvinyl chloride (PVC), used in particular for producing plastic bottles, or else poly(methyl methacrylate) (PMMA), which is used in diverse industrial segments, ranging from dental prosthesis to wind turbine blades.

The term “(meth)acrylic monomer” means any type of acrylic and methacrylic monomer.

The term “(meth)acrylic polymer” means a polymer essentially comprising (meth)acrylic monomers, which represent at least 50% by weight or more of the (meth)acrylic polymer.

By “poly(methyl methacrylate)” or “PMMA” is meant, for the purposes of the invention, homopolymers and copolymers of methyl methacrylate (MAM), the weight ratio of MAM in the PMMA being preferably at least 70% by weight for the MAM copolymer.

The term “pyrolysis” means the chemical decomposition of substances by heat treatment, for heating the substances to a temperature enabling the production of a gas and/or a condensate and/or a sooty residue.

By “microwaves” are meant electromagnetic waves having a wavelength of between, for example, 1 meter and 1 centimeter, but also ultrashort waves and short waves. Hence, the microwaves in the sense of the invention have a frequency of between 10 MHz and 30 GHz and preferably between 900 MHz and 2500 MHz.

By “microwave depolymerization sensitizer compound” is meant a compound which absorbs the electromagnetic microwave radiation and returns it in the form of heat. Expressed alternatively, the microwave depolymerization sensitizer compound is a material having a high dielectric loss factor of, for example, greater than 0.1 at a frequency of between 900 MHz and 2500 MHz and at 25° C., and/or having a high dielectric constant of, for example, greater than or equal to 5 at a frequency of between 900 MHz and 2500 MHz and at 25° C., such that exposing the material to microwave electromagnetic radiation will translate into a rapid heating of said material, and/or having a loss tangent of greater than or equal to 1 at a frequency of between 900 MHz and 2500 MHz and at 25° C.

The term “relative permittivity or dielectric constant of a material or a substance” means the faculty of said material or substance to polarize, i.e., the capacity to be oriented by the electrical field.

By “dielectric loss factor” for the microwave sensitizer compound is meant the inherent dissipation of the electromagnetic energy of a dielectric material (for example, heat). It may be calculated as a function of the loss angle δ or the corresponding loss tangent tan δ. It conveys the efficacy of the conversion of the energy of the electrical field into heat. Accordingly, the dielectric loss factor allows an assessment of the aptitude of a material to undergo heating under the action of microwave radiation.

By “ferrite” is meant ferrimagnetic oxides containing primarily Fe³⁺ions.

The term “substantially equal” for the purposes of the invention refers to a value varying by less than 30% relative to the value compared, preferably by less than 20%, more preferably by less than 10%.

By “part not sensitive to microwaves” is meant a part of the article that has a low dielectric loss factor, or a part which is unaffected or little affected by microwave radiation.

By “part sensitive to microwaves” is meant a part made from a composition comprising a thermoplastic polymer precursor and at least one sensitizer.

The terms “comprise” or “contain” do not exclude other elements or other steps. The various characteristics presented and/or claimed may be advantageously combined. Their presence in the description or in the various dependent claims does not exclude this possibility. The reference signs should not be interpreted as limiting the scope of the invention.

In the description of embodiments below and in the figures of the attached drawings, the same elements or similar elements carry the same numerical references to the drawings.

The inventor has developed a thermoplastic composition which has recycling attributes. The thermoplastic composition of the invention comprises at least one thermoplastic polymer precursor and a microwave depolymerization sensitizer compound.

The thermoplastic polymer precursor is suitable for forming the thermoplastic matrix of an article. It may be selected, for example, from compounds containing acrylate or methacrylate, carbonate, ester, styrene, sulfone or vinyl acetate groups, or a mixture thereof.

The at least one thermoplastic polymer precursor may preferably also correspond to a mixture comprising a (meth)acrylic monomer, or a mixture of (meth)acrylic monomers, a (meth)acrylic polymer or oligomer, and at least one radical initiator.

For its part, the (meth)acrylic liquid thermoplastic composition may comprise a (meth)acrylic monomer, a precursor (meth)acrylic polymer, and a radical initiator, as described in WO2013056845 and WO2014013028.

Moreover, in the production of polymer articles, the viscosity of the (meth)acrylic liquid composition should be regulated and adapted so as to be not too fluid or too viscous, in order to make the composition easier to handle and to maintain the sensitizer in suspension. Moreover, in the context of the production of a polymer composite article, a controlled viscosity may allow the reinforcement to be properly impregnated. The reason is that when wetting is partial, either because the syrup is too fluid or too viscous, “naked” zones, by which are meant unimpregnated zones, appear, and zones in which polymer droplets are formed on the reinforcement (e.g., the fibers), which are the cause of the formation of bubbles, respectively. These “naked” zones and these bubbles give rise to the appearance of defects in the part made of polymer composite or the final object made of polymer composite, which are the cause, inter alia, of a loss of mechanical strength of the part made of polymer composite or the final object made of polymer composite. Thus, said liquid (meth)acrylic composition preferably has a dynamic viscosity of between 10 mPa*s and 10 000 mPa*s at 25° C. The dynamic viscosity of the liquid composition or of the (meth)acrylic syrup is in a range from 10 mPa*s to 10000 mPa*s, preferably from 20 mPa*s to 7000 mPa*s and advantageously from 20 mPa*s to 5000 mPa*s. The viscosity of the liquid (meth)acrylic composition, or liquid (meth)acrylic syrup, can be easily measured with a rheometer or a viscometer. The dynamic viscosity is measured at 25° C. If the liquid (meth)acrylic syrup exhibits Newtonian behavior, meaning without shear thinning, the dynamic viscosity is independent of the shearing in a rheometer or the speed of the spindle in a viscometer. If the liquid composition exhibits non-Newtonian behavior, i.e. with shear thinning, the dynamic viscosity is measured at a shear rate of Is⁻¹ at 25° C.

The (meth)acrylic monomer—the monomer is selected from acrylic acid, methacrylic acid, acrylic alkyl ester monomers, methacrylic alkyl ester monomers, acrylic hydroxyalkyl ester monomers, and methacrylic hydroxyalkyl ester monomers, and mixtures of these. The (meth)acrylic monomer is preferably selected from acrylic acid, methacrylic acid, acrylic hydroxyalkyl ester monomers, methacrylic hydroxyalkyl ester monomers, acrylic alkyl ester monomers, methacrylic alkyl ester monomers, and mixtures of these, with the alkyl group containing from 1 to 22 linear, branched or cyclic carbons; the alkyl group containing from 1 to 12 linear, branched or cyclic carbons.

Advantageously, the (meth)acrylic monomer is selected from methyl methacrylate, ethyl methacrylate, methyl acrylate, ethyl acrylate, methacrylic acid, acrylic acid, n-butyl acrylate, isobutyl acrylate, n-butyl methacrylate, isobutyl methacrylate, cyclohexyl acrylate, cyclohexyl methacrylate, isobornyl acrylate, isobornyl methacrylate, hydroxyethyl acrylate and hydroxyethyl methacrylate, and mixtures thereof.

According to a preferred embodiment, at least 50% by weight and preferably at least 60% by weight of the (meth)acrylic monomer is methyl methacrylate.

According to a first more preferred embodiment, at least 50% by weight, preferably at least 60% by weight, more preferably at least 70% by weight, advantageously at least 80% by weight and even more advantageously 90% by weight of the monomer is a mixture of methyl methacrylate with optionally at least one other monomer.

For the precursor (meth)acrylic polymer, mention may be made of poly(alkyl acrylate) or poly(alkyl methacrylate). According to a preferred embodiment, the (meth)acrylic polymer is poly(methyl methacrylate)(PMMA).

According to one embodiment, the homopolymer or copolymer of methyl methacrylate (MAM) comprises at least 70%, preferably at least 80%, advantageously at least 90%, and more advantageously at least 95% by weight of methyl methacrylate.

According to another embodiment, the PMMA is a mixture of at least one homopolymer and at least one copolymer of MAM, or a mixture of at least two homopolymers or two copolymers of MAM with a different average molecular weight, or a mixture of at least two copolymers of MAM having a different monomeric composition.

The methyl methacrylate (MAM) copolymer may comprise from 70% to 99.9% by weight of MAM and from 0.1% to 30% by weight of at least one second monomer having at least one ethylenic unsaturation for copolymerizing with the MAM, or from 70% to 99.7% by weight of MAM and from 0.3% to 30% by weight of at least one second monomer having at least one ethylenic unsaturation for copolymerizing with the MAM. The second monomer may be, for example, styrene, alpha-methylstyrene, acrylic and methacrylic acids, and alkyl (meth)acrylates in which the alkyl group contains from 1 to 12 carbon atoms.

These monomers are well known and mention may particularly be made of acrylic and methacrylic acids and alkyl (meth)acrylates in which the alkyl group contains from 1 to 12 carbon atoms. By way of examples, mention may be made of methyl acrylate and ethyl, butyl or 2-ethylhexyl (meth)acrylate. Preferably, the comonomer is an alkyl acrylate in which the alkyl group contains from 1 to 4 carbon atoms.

According to a first preferred embodiment, the methyl methacrylate (MAM) copolymer comprises from 80% to 99.7%, advantageously from 90% to 99.7%, and more advantageously from 90% to 99.5% by weight of methyl methacrylate and from 0.3% to 20%, advantageously from 0.3% to 10%, and more advantageously from 0.5% to 10% by weight of at least one monomer containing at least one ethylenic unsaturation which is able to copolymerize with the methyl methacrylate. Preferably, the comonomer is selected from methyl acrylate and ethyl acrylate, and mixtures thereof.

According to a second preferred embodiment, the methyl methacrylate (MAM) copolymer comprises from 80% to 99.9%, advantageously from 90% to 99.9%, and more advantageously from 90% to 99.9% by weight of methyl methacrylate and from 0.1% to 20%, advantageously from 0.1% to 10%, and more advantageously from 0.1% to 10% by weight of at least one monomer containing at least one ethylenic unsaturation which is able to copolymerize with the methyl methacrylate. Preferably, the comonomer is selected from methyl acrylate and ethyl acrylate, and mixtures thereof.

The weight-average molecular mass (M_{w}) of the precursor (meth)acrylic polymer is preferably high, in other words greater than 50 000 g/mol and preferably greater than 100 000 g/mol. The weight-average molecular weight may be measured by size exclusion chromatography. Furthermore, the precursor (meth)acrylic polymer may have a degree of polymerization of greater than or equal to 500 and more preferably greater than or equal to 1000.

The precursor (meth)acrylic polymer is fully soluble in the (meth)acrylic monomer or in the mixture of (meth)acrylic monomers. It enables the viscosity of the (meth)acrylic monomer or the mixture of (meth)acrylic monomers to be increased. The liquid composition or solution obtained is generally referred to as “syrup” or “prepolymer”. The dynamic viscosity value of the liquid (meth)acrylic syrup is between 10 mPa·s and 10 000 mPa·s. The viscosity of the syrup may be readily measured with a rheometer or a viscometer. The dynamic viscosity is measured at 25° C. Advantageously, the liquid (meth)acrylic syrup contains no additional solvent added intentionally.

As far as the radical initiator is concerned, mention may be made of preferably water-soluble radical polymerization initiators or of liposoluble or partially liposoluble radical polymerization initiators.

The water-soluble radical polymerization initiators are notably sodium, potassium or ammonium persulfates, used alone or in the presence of reducing agents such as sodium metabisulfites or hydrosulfites, sodium thiosulfate, sodium formaldehyde-sulfoxylate, a mixture of disodium salt of 2-hydroxy-2-sulfinoacetic acid, sodium sulfite and disodium salt of 2-hydroxy-2-sulfoacetic acid, or else a mixture of disodium salt of hydroxysulfinoacetic acid and disodium salt of hydroxysulfoacetic acid.

The liposoluble or partially liposoluble radical polymerization initiators are notably peroxides or hydroperoxides and derivatives of azobisisobutyronitrile. The peroxides or hydroperoxides are used in combination with the reducing agents described previously so as to lower their activation temperature.

The mass percentage of initiator relative to the total weight of monomer mixture is preferably between 0.05% by weight and 3% by weight, preferably between 0.1% by weight and 2% by weight.

The weight-average molecular mass of the thermoplastic (meth)acrylate matrix formed after polymerization is generally high—for example, it may be greater than 50 000 g/mol, and preferably greater than 100 000 g/mol.

The thermoplastic composition of the invention further comprises a microwave radiation depolymerization sensitizer.

The dielectric loss factor of the microwave depolymerization sensitizer is preferably greater than or equal to 0.1 at a frequency of between 900 MHz and 2500 MHz and at 25° C., more preferably greater than or equal to 0.2, and more preferably still greater than or equal to 10. Accordingly, the sensitizer compound absorbs the microwave energy more rapidly than does the thermoplastic polymer, then dissipates this energy in the form of heat, so giving rise to rapid heating. More preferably, the dielectric loss factor of the microwave depolymerization sensitizer is greater than or equal to 0.2 at 2.45 GHz and 25° C., and more preferably still the dielectric loss factor of the microwave depolymerization sensitizer is greater than 10 at 2.45 GHz and 25° C.

The sensitizer component preferably has a dielectric constant of greater than or equal to 5 at a frequency of between 900 MHz and 2500 MHz and at 25° C., more preferably greater than or equal to 20, and more preferably still greater than or equal to 50. More preferably, the sensitizer compound has a dielectric constant of greater than 20 at 2.45 GHz and 25° C., and more preferably still of greater than 50 at 2.45 GHz and 25° C.

The sensitizer compound preferably has a loss tangent of greater than or equal to 10⁻⁴ at a frequency of between 900 MHz and 2500 MHz and at 25° C., more preferably of greater than or equal to 10⁻², and more preferably still of greater than or equal to 0.1—for example, greater than or equal to 0.5. Thus the sensitizer compound will be capable of absorbing a large amount of energy originating from the microwave radiation. More preferably, the sensitizer compound has a dielectric constant of greater than 20 at 2.45 GHz and 25° C., and more preferably still of greater than 50 at 2.45 GHz and 25° C.

The dielectric loss factor and the dielectric constant are parameters which are dependent in particular on the frequency applied and on the temperature of the material. These parameters are preferably measured by the method described in “Chauffage diélectrique—Principes et spécificités”, Techniques de l'Ingénieur D 5 940−1, Roussy G. et al. 2008.

For example, a microwave depolymerization sensitizer may be:
an oxide such as Al₂O₃, (Ba₁₋ₓSrₓ)TiO₃, BaTiO₃, Ba(ZrxTi1,)O₃, Ca—Si—Al—O, CaTiO₃, Cr₂O₃, CuO, Fe₂O₃, Fe₃O₄, LaAlO₃, LaCrO₃, MnO₂, NiO, (Pb_{1-x-y}LaₓZr_{y})TiO₃, (PbₓMg₁₋ₓ)NbO₃, PbTiO₃, Ta₂O₅, TiO₂, YBa₂Cu₃O₇, ZnO, ZrO₂, SrTiO₃, Sr(Zr xTi₁₋ₓ)O₃, FeO(OH), MgTiO₃, Ta₂O₅, (ZrₓSi₁₋ₓ)O₂, MgCO₃, where x, y, and x+y are between 0 and 1 (endpoints included),
a non-oxide such as CrB, Fe₂B, FeSi, Mg, Si,
a carbide such as silicon carbide SiC,
calcium aluminate;
a carbon filler such as carbon black, carbon fiber, graphite, activated carbon, carbon nanotubes, charcoal,
ferrites, such as bismuth ferrite (BiFeO₃),
a metal complex such as YBa₂Cu₃O₇, LaCrO₃, CuO, CuFeS₂, ZnCl₂, Ni phosphate, chalcopyrite, cordierite, zeolite, steatite,
a nitride such as aluminum nitride, boron nitride,
a silicate,
a fluoride such as cerium fluoride, (Ba_{1-x-y}CaₓSr_{y})F₂, where x, y, and x+y are between 0 and 1 (endpoints included),
or a mixture thereof.

Examples of microwave depolymerization sensitizers with their dielectric properties at different frequencies are given in table 1.

TABLE 1

| | Measurement | | | |
|---|---|---|---|---|
| | frequency | Dielectric | 10⁴ × | |
| Sensitizer | (in MHz) | constant | Tan delta | Loss factor |
| Al₂O₃ | 1000 | 9.6-10 | 2 | 0.0019-0.002 |
| Al₂O₃ | 3600 | 9 | 5 | 0.0045 |
| Aluminum nitride | 8500 | 8 | 35 | 0.028 |
| Amber | 3000 | 2.6 | 90 | 0.0207 |
| BaF₂ | 1000 | 7.3 | 10 | 0.0073 |
| BaTiO₃ | 2450 | 200-16 000 | | 0.2-0.3 |
| BiFeO₃ | 9400 | 40 | 700 | 2.8 |
| Boron nitride | 8500 | 4.37 | 3 | 0.0013 |
| Boron nitride | 100 | 4.08 | 2.6 | 0.0011 |
| CaF₂ | 1000 | 6.5 | 10 | 0.0065 |
| Carbon black | 2500 | 20 | 5000 | 10 |
| Cerium fluoride | 60 | 15.8 | 2530 | 4 |
| Chalcopyrite | 2450 | 11.01 | 7284 | 8.02 |
| Ferrites | 1000-10 000 | 10-100 | 100-10 000 | 1-100 |
| Basalt | 8500 | 10.2 | 5600 | 5.7 |
| Basalt | 1000 | 3.51 | 481 | 0.1688 |
| LaAlO₃ | 1 | 350 | 10 | 0.35 |
| Limestone | 14 000 | 8.21-8.45 | 38-80 | 0.0311-0.0668 |
| (Lucerne Valley) | | | | |
| Cordierite | 8520 | 4.8 | 25 | 0.012 |
| Magnesium | 8520 | 1.282 | 109 | 0.0139 |
| carbonate | | | | |
| Magnesium | 14 000 | 6.37 | 12 | 0.0076 |
| metasilicate | | | | |
| Magnesium | 8500 | 6.59 | 8 | 0.0053 |
| orthosilicate | | | | |
| Marble | 1 | 8 | 400 | 0.24 |
| MgOAl₂O₃ | 4070-4023 | 8.28 | 1 | 0.0008 |
| MgTiO₃ | 10 | 20 | 100 | 0.2 |
| SiC | 1000 | 107 | 6860 | 73.4 |
| SiC | 3000 | 60 | 5800 | 34.8 |
| SiC | 8500 | 47.7 | 5500 | 26.2 |
| Silicon | 1000-10 000 | 11.7-12.9 | 50-150 | 0.0585-0.19 |
| Sodium silver | 9400 | 4.5 | <100 | <0.045 |
| nitrite | | | | |
| SrF₂ | 1000 | 6.5 | 10 | 0.0065 |
| Steatite | 1000 | 6 | 20 | 0.012 |
| Strontium | 1 | 200 | 5 | 0.1 |
| titanate | | | | |
| Strontium | 1 | 38 | 3 | 0.038 |
| zirconate | | | | |
| TiO₂ | 1000 | 80 | 8-30 | 0.0640-0.24 |
| Zirconium | 10 | 10 | 100 | 0.1 |
| silicate | | | | |
| ZrO₂ | 1000 | 30 | 33 | 0.1 |

More particularly, the sensitizer compound may be selected from the following: SiC, TiO₂, ZrO₂, BaTiO₃, SrTiO₃, MgTiO₃, CaTiO₃, LaAlO₃, ferrites, basalt, marble and mixtures thereof.

Preferably, the sensitizer compound may be selected from the following: SiC, TiO₂, ZrO₂, marble and mixtures thereof.

Alternatively, likewise preferably, the sensitizer compound may be selected from the following: ferrites, barium titanate, strontium titanate, calcium titanate, magnesium titanate, and mixtures thereof.

The amount of microwave depolymerization sensitizer in the thermoplastic composition may be from 0.1% to 50% by weight of the thermoplastic composition, preferably less than 10%, more preferably less than 0.5 to 5% by weight of the thermoplastic composition. Advantageously, a minimum amount of sensitizer is used so as to minimize other effects of the sensitizer on the properties of the thermoplastic composition and/or of the articles which may be manufactured with this composition.

The composition may further comprise at least one additive such as a stabilizer, a pigment, a plasticizer such as phthalates, an adhesion promoter, a UV absorber, an antioxidant, a flame retardant, a dye, a lubricant, a demolding agent, a filler, an antistatic agent, a fungicide, a surfactant and/or crosslinked polymer beads, etc. Adding an additive makes it possible, advantageously, to enhance the properties of the thermoplastic composition. For example, fillers enhance the heat resistance or chemical resistance, plasticizers enable a reduction in stiffness, stabilizers prevent the degradation of the polymers, antistats prevent the deposition of dust, lubricants limit wear, flame retardants offer better fire resistance, etc.

The percentage by mass of the additives and fillers collectively, relative to the total weight of (meth)acrylic thermoplastic composition, is preferably less than 30% by weight, preferably less than 10% by weight.

In a variant, the thermoplastic composition may comprise at least one solvent for the thermoplastic polymer.

According to another aspect, the invention relates to a method for manufacturing an article, comprising:
a step of preparing a thermoplastic composition according to the invention,
optionally, a step of impregnating a reinforcement with said composition, and
a step of forming said article from the composition.

The manufacture of an article from the thermoplastic composition comprising a microwave depolymerization sensitizer includes the step of preparing said composition.

The thermoplastic composition may be prepared by any industrial method allowing the sensitizer compound to be mixed with the at least one thermoplastic polymer precursor.

The manufacturing method likewise includes a step of polymerizing the at least one thermoplastic polymer precursor so as to form a thermoplastic matrix. Hence the method for manufacturing an article according to the invention may comprise the generation of a thermoplastic matrix from the at least one thermoplastic polymer precursor. The thermoplastic matrix may be obtained by any methods for producing polymer compositions that are known to the skilled person: for example, by any type of controlled radical polymerization or by anionic polymerization or else by photopolymerization on the basis of the monomer components. The polymerization reaction may be carried out in any type of suitable device such as extrusion, injection molding or compression molding devices.

With reference to FIG. 1, the at least one thermoplastic polymer precursor 1 and the microwave depolymerization sensitizer compound 2 are introduced into an extruder 10, via a hopper 4, for example. In the extruder, the mixture is heated and softened, with the aid of a continuous screw 5 which is located in a tube 6 which is heated in order to make the pellets malleable. A polymeric matrix in the melted state is then obtained, which is driven to the outlet 8 by means of the screw 5. The outlet head of the extruder imposes its shape on the polymeric matrix, which is cooled at the exit to be converted into pellets (not shown in FIG. 1). When it has been prepared, the thermoplastic matrix takes the form of pellets or powder.

The thermoplastic matrix , which may be obtained from the at least one thermoplastic polymer precursor, is a matrix comprising thermoplastic polymers, such as linear or branched polymers which are not crosslinked and have a certain malleability, hence making it easier for them to be shaped by application of heat and pressure. The thermoplastics regain their initial stiffness after cooling, and do so without the material being thermally degraded.

A thermoplastic polymer which can be employed in the thermoplastic matrix may be, for example: a homo- and copolymer of olefins, such as acrylonitrile-butadiene-styrene copolymers, styrene-butadiene-alkyl methacrylate (or SBM) copolymers; polyethylene, polypropylene, polybutadiene, and polybutylene; acrylic homo- and copolymers and polyalkyl (meth)acrylates such as poly(methyl methacrylate); homo- and copolyamides; polycarbonates; polyesters, including poly(ethylene terephthalate) and poly(butylene terephthalate); polyethers such as poly(phenylene ether), poly(oxymethylene), poly(oxyethylene) or poly(ethylene glycol) and poly(oxypropylene); polystyrene; copolymers of styrene and maleic anhydride; poly(vinyl chloride); fluoropolymers such as poly(vinylidene fluoride), polyethylene tetrafluoride, and polychlorotrifluoroethylene; natural or synthetic rubbers; thermoplastic polyurethanes; polyaryl ether ketones (PAEK) such as polyetheretherketone (PEEK) and polyetherketoneketone (PEKK); polyetherimide; polysulfone; poly(phenylene sulfide); cellulose acetate; poly(vinyl acetate); and mixtures thereof.

Examples of dielectric constant and loss factor values for certain thermoplastics at 2450 MHz are given in table 2, and at 1000 MHz in table 3.

TABLE 2

| | Dielectric | Loss factor |
|---|---|---|
| | constant | at 2450 MHz |
| Thermoplastic | at 2450 MHz (e′) | (e″) |
| Polyamide | 3.0 | 0.04 |
| Polyester | 4.0 | 0.04 |
| Polyethylene | 2.25 | 0.001 |
| Polystyrene | 2.55 | 0.0005 |
| Polyethylene tetrafluoride | 2.1 | 0.0003 |
| Poly(vinyl chloride) | 2.9 | 0.1 |
| PMMA | 2.6 | 0.015 |

TABLE 3

| | Dielectric | |
|---|---|---|
| | constant | Loss factor |
| Thermoplastic | at 1000 MHz | at 1000 MHz |
| ETFE (ethylene-tetrafluoroethylene | 2.4 | 0.0005 |
| copolymer) | | |
| FEP (fluorinated ethylene-propylene | 2.05 | 0.0015 |
| copolymer) | | |
| PFA (perfluoroalkoxy) | 2.0-2.1 | 0.00045 |
| PCTFE (polychlorotrifluorethylene) | 2.3 | 0.004 |
| PTFE (polytetrafluoroethylene) | 2.0-2.1 | <0.0001 |
| PC (polycarbonate) | 2.89 | 0.012 |
| PET (polyethylene terephthalate) | 2.8 | 0.003-0.008 |
| LDPE (low density polyethylene) | 2.2 | 0.0003 |
| LLDPE (linear low density | 2.2 | 0.0003 |
| polyethylene) | | |
| HDPE (high density polyethylene) | 2.3 | 0.0005 |
| PMMA (polymethyl methacrylate) | 2.58 | 0.009 |
| PP (polypropylene) | 2.2 | 0.0003 |
| PS (polystyrene) | 2.4-2.7 | 0.0005 |
| PVC (polyvinyl chloride) | 2.8 | 0.019 |
| PVDC (polyvinylidene chloride) | 2.7 | 0.016 |
| Molded ABS (acrylonitrile- | 2.0-3.5 | 0.005-0.0190 |
| butadiene-styrene) | | |

As presented in tables 2 and 3, the thermoplastic polymers do not have a high dielectric loss factor. In this case, the incorporation of a microwave sensitizer will be all the more advantageous and will enable the production of an article which will be able to be heated more rapidly and selectively, so allowing a gain in time and energy relative to traditional heating such as thermal pyrolysis. Hence, preferably, the thermoplastic matrix comprises a polymer having a dielectric loss factor of less than or equal to 0.1, as measured at 2450 MHz and at 25° C., more preferably less than or equal to 0.05, and more preferably still less than or equal to 0.02.

More particularly, the thermoplastic matrix of the article is a poly(methyl methacrylate) (PMMA) matrix in which a sensitizer is incorporated.

The thermoplastic composition or the thermoplastic matrix may subsequently be converted into articles or parts by any conventional plastics technology process, such as extrusion, coextrusion, thermoforming, injection molding, compression molding, blow molding, multimaterial injection molding, or sheet casting. The processes set out are nonlimiting. Accordingly, from its conception, the article formed from the thermoplastic composition has the advantage of being recyclable rapidly and with a reduced energy cost. The thermoplastic composition may be used for producing parts, profiles, sheets or film, for example.

Accordingly, the invention likewise concerns an article comprising a thermoplastic matrix formed from the thermoplastic composition according to the invention.

The article formed from the thermoplastic composition may comprise the microwave depolymerization sensitizer compound in the entirety of the mass of thermoplastic polymer. More particularly, the article may consist entirely of the thermoplastic composition comprising the thermoplastic matrix and the sensitizer compound.

In a variant embodiment, the article may not consist entirely of the thermoplastic composition. The article may comprise a sensitizer compound only over part of the mass of the thermoplastic matrix. For example, the article may comprise a first portion and at least one second portion. The first portion may be made from the thermoplastic composition and then comprises the depolymerization sensitizer compound. The at least one second portion may be made without depolymerization sensitizer. For example, the first portion may be made from a PMMA thermoplastic composition with a sensitizer. The second portion may be a reinforcement or a polymer mass containing no microwave depolymerization sensitizer.

The first portion and a second portion may subsequently be joined by gluing to give an article. An article of this kind has the advantage of being selectively depolymerizable without prior sorting. The glue may or may not contain a microwave sensitizer, depending on the interference thereof with the monomer during its thermal degradation. The reason is that, during the microwave depolymerization, the portion comprising the sensitizer compound is heated selectively and rapidly. The portion comprising the thermoplastic composition of the invention may therefore reach a melted state, whereas the portion without sensitizer, made of composite, for example, does not heat up. This then makes it easier to separate the melted thermoplastic material from the unmelted portion. Improved waste treatment may therefore be performed, by virtue of the invention.

Advantageously, the thermoplastic composition comprising at least one thermoplastic polymer precursor and at least one microwave sensitizer compound may be used for producing composite materials. A composite material of this kind may comprise, for example, besides the thermoplastic matrix and the microwave depolymerization sensitizer compound, a reinforcement, such as a fibrous reinforcement or a mineral filler.

Fibrous reinforcement generally refers to a plurality of fibers, unidirectional rovings or a continuous filament mat, fabrics, felts or nonwovens which may be in the form of strips, webs, braids, strands or parts. More particularly, a fibrous reinforcement comprises an assembly of one or more fibers, generally several fibers, said assembly being able to have different forms and dimensions; one-dimensional, two-dimensional or three-dimensional. The one-dimensional form corresponds to linear long fibers. The fibers may be discontinuous or continuous. The fibers may be arranged randomly or parallel to one another, in the form of a continuous filament. The two-dimensional form corresponds to nonwoven reinforcements or fibrous mats or woven rovings or bundles of fibers, which may also be braided. Even if the two-dimensional form has a certain thickness and consequently in principle a third dimension, it is considered to be two-dimensional according to the present invention. The three-dimensional form corresponds, for example, to stacked or folded nonwoven fibrous reinforcements or fibrous mats or stacked or folded bundles of fibers or mixtures thereof; an assembly of the two-dimensional form in the third dimension.

The fibrous reinforcement may be made, for example, of glass fiber, carbon fiber, aramid fiber, a natural fiber such as flax or hemp; this list is nonlimiting.

The fibers of the fibrous reinforcement have for example a diameter of between 0.005 μm and 100 μm, preferably between 1 μm and 50 μm, more preferably between 5 μm and 30 μm and advantageously between 10 μm and 25 μm.

Preferably, the fibers of the fibrous reinforcement of the present invention are selected from continuous fibers for the one-dimensional form, or from long or continuous fibers for the two-dimensional or three-dimensional form of the fibrous reinforcement.

The composite material may be produced in a compounding device, as before, in which the thermoplastic composition comprising the at least one thermoplastic polymer precursor and the microwave sensitizer compound is introduced. The mixture is brought to the melted state so as to be mixed by means of a high-shear device such as a corotating twin-screw extruder or a co-kneader. The composition of the invention in melted form may then be used for a step of impregnating the fibrous reinforcement so as to give a composite material. One of the advantages of the present invention is that the thermoplastic polymer composite materials can be manufactured at a temperature of less than 150° C., preferably less than 120° C., more preferably less than 100° C. For example, the step of impregnating the fibrous reinforcement with the (meth)acrylic liquid composition is carried out at a temperature of less than 150° C., preferably less than 120° C., more preferably less than 100° C., or less than 80° C. The reason is that the (meth)acrylic liquid composition, advantageously used for manufacturing thermoplastic polymer composite materials, is liquid at a much lower temperature than the conventional melting temperatures of conventional thermoplastics. Accordingly, this makes it possible to produce thermoplastic polymer composite materials of very great size, without having to employ methods in which said parts are heated to high temperatures. Furthermore, a step of polymerizing the (meth)acrylic liquid composition impregnating said material may be carried out optionally.

A composite material of this kind may be used for manufacturing a composite article or polymer composite part. This polymer composite part has the advantage that it can be depolymerized selectively when used in an assembly with parts not manufactured from the thermoplastic composition comprising a microwave depolymerization sensitizer.

The invention also relates to a method for recycling 100 an article made entirely or partially from the thermoplastic composition comprising a depolymerization sensitizer.

The recycling method 100 may be implemented, for example, by any type of existing depolymerization system for plastic. For example, as shown in FIG. 2, the recycling system 20 may comprise:
a reactor 22 for receiving the article or the object 3 for recycling,
connection means 24, such as conduits, which are adapted for connection to a vacuum pump or to a circuit for distributing gas such as an inert gas, examples being nitrogen (N₂), carbon dioxide (CO₂), depleted air, or argon (Ar),
a microwave generator 25, a magnetron or a klystron for example, which converts electrical energy into microwave radiation,
a waveguide 26 for transferring the microwave energy from the generator to the reactor.

The system may also comprise a thermal camera 27 which allows an estimate to be made of the temperature of an article or a part placed in the reactor, and which is advantageously combined with a sorting device. Sorting then precedes depolymerization, which may be carried out by conventional means. The recycling system of the invention may advantageously further comprise an infrared spectroscope and/or a Raman spectroscope.

Moreover, the system may comprise elements which are not shown in this figure, such as a pressure regulation valve, a temperature sensor, a pressure sensor, a condenser for condensing the gases resulting from the depolymerization, a stirrer for mixing the wastes in the reactor, a separating grid for isolating the residues, and/or a collector for collecting the fluids produced during the depolymerization.

The recycling method is a method which may advantageously comprise microwave-assisted depolymerization, which may be viewed as a depolymerization in which heating is obtained by application of microwave radiation. The heating induced by the microwaves has the advantage of being rapid and localized in the zones containing the sensitizer compound. It takes place within the volume of the sample, without a thermal gradient, in contradistinction to conventional heating, which involves a gradient by convection through the walls of the reactor.

Alternatively, the heating may lead to a conversion of the article for recycling that does not correspond to a depolymerization. Thus the heating may lead to liquefaction or gasification of at least part of the article for recycling.

According to one embodiment, the depolymerization process may comprise:
the placement 110 of the article in a reactor adapted for microwave-assisted depolymerization,
the application 120 of microwave radiation, at a given frequency, to the article placed in the reactor,
the initiation 130 of the depolymerization, by absorption of microwaves by a microwave sensitizer, for a given time so as to reach a given temperature in the reactor, and
the conversion 140 of at least part of the article into liquid or gas corresponding to at least one monomer of the thermoplastic matrix.

The method may further comprise, before the step of placing the article in a reactor for depolymerization, for example, a step:
of grinding the article for recycling until flakes are obtained, and/or
washing the flakes obtained after grinding, and/or
rinsing, draining, drying and/or screening.

The method may also comprise a sorting step which is based on the acquisition and processing of data originating from a thermal camera. The data originating from a thermal camera may advantageously be supplemented by infrared and/or Raman spectroscopy data. The sorting operation may therefore precede an operation of mechanical or thermal recycling, including by conventional means.

With reference to the diagram in FIG. 3, the recycling method 100 will be described for the case in which the article for recycling is an article fabricated entirely from a composition comprising poly(methyl methacrylate) and a microwave depolymerization sensitizer compound.

In a step 110, the article is placed in the reactor of a recycling system, preferably in a depolymerization system. The reactor is preferably operated under vacuum so as to extract the monomer in the gas state (e.g., MAM) as rapidly as possible from the depolymerization zone. The reactor is operated continuously, with the polymer being fed in at one end. The residence time of the polymer in the facility and the rate of depolymerization are controlled by the product throughput. The length of the zone exposed to the microwaves is adjusted by multiplying the number of waveguides along the reactor. The depth of penetration is determined by the dielectric parameters of the product. Advantageously, therefore, the reactor is substantially flat, so that the entirety of the product is exposed to the microwaves.

The product moves within the reactor either by gravity, by mixing, or else by piston displacement. In the first case, the reactor is supplied from the top, and the residual product is withdrawn from the bottom. This configuration is particularly advantageous for implementing short residence times. The rate of withdrawal at the foot of the reactor determines the residence time in the zone of microwave irradiation. In the second case, the mixing allows the polymer to be displaced toward the other end of the reactor. In the third case, the polymer is pushed by a continuous or discontinuous piston (the polymer to be treated is pushed, and then the piston is recharged to carry out a further displacement). In this configuration, the flow of the solid may take place in different directions. For example, the solid is introduced from the bottom of the reactor and pushed toward the top, and the depolymerization gases are drawn off from the top of the reactor. In this way, the gases are in contact with the sooty residues which exit the reactor at the top. These residues are porous. They undergo gradual cooling. A particular advantage of this configuration of the reactor is that the heavy products which are removed with the monomer (dimers, oligomers, and other heavy decomposition products) recondense gradually on the sooty residue through which the depolymerization gases pass. The effluent leaving the reactor is therefore depleted in heavy products. The gases are subsequently condensed, and the monomer (e.g., MAM) is purified by distillation.

In a step 120, the article is subjected to microwave radiation of a given frequency for a given time. It is possible to utilize very low-frequency radiation in order to enhance penetration within the material, in which case it is possible to go down to 10 MHz. It is, moreover, preferable to select a frequency at which the sensitizer compound has values for dielectric constant and for loss tangent that promote a rapid rise in the temperature, such as values, respectively, of greater than 0.1 and 10⁻⁴.

In one embodiment, the frequency applied to the article placed in the reactor is between 900 MHz to 2500 MHz and preferably substantially equal to 2450 MHz. The time of irradiation or of exposure to microwaves for an article for treatment may be of the order of minutes. For example, this time may be 5, 10, 20, 30 or 45 min. The exposure time may also be of the order of hours, for example 1 h, 2 h or 3 h. This time is adjusted depending on the volume of wastes to be treated and/or on the size of the articles to be treated.

Applying the microwave radiation for the given time makes it possible to initiate the microwave-assisted depolymerization according to a step 130. Subsequently, during a step 140, there is depolymerization of the thermoplastic matrix of the article. Hence the PMMA polymer matrix is depolymerized and is converted into a viscous residue comprising the methyl methacrylate (MAM) monomer. Advantageously, the PMMA is able to dissolve in the monomer.

The method has the advantage of permitting rapid and selective depolymerization by comparison with the usual methods of depolymerization, such as thermal pyrolysis. The reason is that, by virtue of the sensitizer, the propensity of the PMMA to be heated is increased, and the heating of the PMMA is obtained more rapidly. The result of this is a gain in time.

Furthermore, the microwave radiation is applied to an article for depolymerization, and there is therefore no need for the reactor in which the article is placed to be heated beforehand, as is the case in a conventional pyrolysis. In the case of PMMA, the depolymerization may be carried out at a temperature of greater than 200° C. The object of the method is to heat only the zones in which depolymerization is desired. Hence the sensitizer compound is only in the PMMA and not in the fibers, the foams, and other foreign bodies which are introduced into the composites. The sensitizers are therefore placed in the zones selected for later depolymerization. There are therefore economies of energy realized, since only the part for depolymerization is heated. Preferably, then, the depolymerization may be carried out at an average temperature in the reactor of less than 400° C., more preferably less than 300° C., and more preferably still less than 250° C.

The given temperature in the reactor may be between 70° C. and 500° C. More particularly, the given temperature may be between 100° C. and 200° C., preferably between 110° C. and 190° C. This temperature range is suitable more particularly for the depolymerization of PMMA, which is a polymer of interest. This temperature may be measured by means of a thermal camera, for example.

In the method variants, it is possible to carry out only a partial reaction, in particular with sensitizers for which the permittivity and/or the tangent delta increase(s) with the temperature. In that case, the longer the microwave radiation is performed, the greater the extent to which the heated zone absorbs the microwaves. The effect of this is that the monomer is liquefied and vaporized very locally. If the sensitizer compound is well dispersed, it is then possible to create porosity in the polymer, and numerous sites of initiation of the radical depolymerization. In this case, the microwave treatment may be used as a pretreatment before either a dissolution treatment in the hot monomer, or else as a pretreatment before a conventional thermal treatment. The porosity generated allows the thermal depolymerization to be accelerated.

In one embodiment, the recycling method is a method for depolymerizing an article having one part which is not sensitive to microwaves and one part which is sensitive to microwaves. As before, the article is placed in the reactor of the depolymerization system, and is subjected to microwave radiation of a given frequency for a given time. The depolymerization is then initiated and the heat is generated solely in the part which is sensitive to microwaves, with the part which is not sensitive to microwaves being unaffected by the microwave radiation. Hence it is possible to carry out selective depolymerization of a part of an article.

The process proves to be particularly advantageous when the article for treatment is a composite article comprising, in particular, the thermoplastic composition and fibers—glass fibers, for example. The reason is that, during the depolymerization of the composite articles by conventional depolymerization methods, a high temperature is applied to the whole of the article, especially to the inorganic and organic parts of the composite which cannot be depolymerized. Accordingly, the energy supplied in the conventional methods for depolymerization also serves to heat the undepolymerizable parts. By virtue of the thermoplastic composition of the invention, the depolymerization method may be applied specifically to the thermoplastic composition. The result of this is a gain in time and in energy, so enabling the overall energy costs to be reduced.

The present invention has been described and illustrated in the present detailed description and in the figures of the attached drawings, in possible embodiments. The present invention, however, is not limited to the embodiments presented. Other variants and embodiments may be inferred and employed by the person skilled in the art from a reading of the present description and of the attached drawings.

1. A thermoplastic composition comprising at least one thermoplastic polymer precursor and at least one microwave depolymerization sensitizer compound.

2. The thermoplastic composition as claimed in claim 1, wherein the at least one thermoplastic polymer precursor is selected from compounds containing acrylate, carbonate, ester, styrene, sulfone or vinyl acetate groups or a mixture thereof.

3. The thermoplastic composition as claimed claim 1, wherein the at least one thermoplastic polymer precursor is a liquid (meth)acrylic composition comprising a (meth)acrylic monomer or a mixture of (meth)acrylic monomers, a (meth)acrylic polymer, and at least one radical initiator.

4. The thermoplastic composition as claimed in claim 1, wherein the depolymerization sensitizer compound has a dielectric loss factor of greater than or equal to 0.1 at a frequency of between 900 MHz and 2500 MHz and at 25° C.

5. The thermoplastic composition as claimed in claim 4, wherein the depolymerization sensitizer compound has a dielectric constant of greater than or equal to 5 at a frequency of between 900 MHz and 2500 MHz and at 25° C.

6. The thermoplastic composition as claimed in claim 1, wherein the depolymerization sensitizer compound has a loss tangent of greater than or equal to 10⁻⁴ at a frequency of between 900 MHz and 2500 MHz and at 25° C.

7. The thermoplastic composition as claimed in claim 6, wherein the depolymerization sensitizer compound has a loss tangent of greater than or equal to 10⁻⁴ at a frequency of 2.45 GHz and at 25° C.

8. The thermoplastic composition as claimed in claim 1, wherein the depolymerization sensitizer compound is present in an amount of from 0.1% to 50% by weight of the thermoplastic composition.

9. The thermoplastic composition as claimed in claim 1, wherein the depolymerization sensitizer compound is selected from the group consisting of: SiC, TiO₂, ZrO₂, BaTiO₃, SrTiO₃, MgTiO₃, CaTiO₃, LaAlO₃, ferrites, basalt, marble, and mixtures thereof.

10. The thermoplastic composition as claimed in claim 1, wherein the depolymerization sensitizer compound is selected from the group consisting of: ferrites, barium titanate, strontium titanate, calcium titanate, magnesium titanate, and mixtures thereof.

11. The thermoplastic composition as claimed in claim 1, wherein the depolymerization sensitizer compound is selected from the group consisting of: SiC, TiO₂, ZrO₂, marble, and mixtures thereof.

12. The thermoplastic composition as claimed in claim 1, wherein the depolymerization sensitizer compound is present in an amount of from 0.5% to 5% by weight of the thermoplastic composition.

13. A method for manufacturing an article, comprising:
a step of preparing a thermoplastic composition as claimed in claim 1, and
a step of forming said article from said composition.

14. The manufacturing method as claimed in claim 13, wherein the forming step is selected from the group consisting of extrusion, coextrusion, thermoforming, injection molding, compression molding, extrusion film, blow molding, multimaterial injection molding, and of sheet casting.

15. The manufacturing method as claimed in claim 13, wherein said method further comprises a step of impregnating a reinforcement with said composition.

16. An article comprising a thermoplastic matrix formed from the thermoplastic composition as defined in claim 1.

17. The article as claimed in claim 16, wherein the thermoplastic matrix comprises a thermoplastic polymer having a dielectric loss factor of less than or equal to 0.1, as measured at 2450 MHz and 25° C.

18. The article as claimed in claim 16, wherein the thermoplastic matrix is a matrix selected from the group consisting of: acrylic homo- and copolymers, polyalkyl (meth)acrylates, poly(methyl methacrylate), polycarbonates, polyesters, polystyrene, polyetherimide, polysulfone, poly(phenylene sulfide), poly(vinyl acetate), and of a mixture of two or more of these polymers.

19. The article as claimed in claim 16, wherein the thermoplastic matrix comprises poly(methyl methacrylate).

20. The article as claimed in claim 16, wherein the article is a polymer composite part.

21. The article as claimed in claim 16, wherein said article comprises a plurality of portions of polymeric compounds and in that it comprises at least one sensitizer compound only in part of the portions of said polymeric compounds.

22. The article as claimed in claim 16, wherein said article comprises a plurality of portions of polymeric compounds and in that it comprises at least one sensitizer compound in the entirety of the portions of polymeric compounds.

23. The article as claimed in claim 21, wherein the portions are joined by gluing.

24. A method for recycling an article as claimed in claim 16, comprising:
placing the article in a reactor, and
subjecting the article placed in the reactor to microwave radiation at a frequency of between 10 MHz and 5.8 GHz.

25. The recycling method as claimed in claim 24, wherein the microwave radiation has a frequency of between 900 MHz and 2500 MHz.

26. The recycling method as claimed in claim 24, wherein further comprises a step of reducing the weight of the article.

27. The recycling method as claimed in claim 24, further comprising:
initiating the depolymerization by absorption of microwaves by a microwave sensitizer, and
converting at least part of the article into at least one monomer of the thermoplastic matrix.

28. The recycling method as claimed claim 24, wherein the microwave radiation is applied until the weight of the article is reduced by at least 10%.

29. The recycling method as claimed in claim 24, comprising a prior step of applying microwave radiation and of measuring the temperature of the articles in order to determine if the article is an article to be recycled.

30. A method for recycling an article comprising a thermoplastic matrix formed from a thermoplastic composition comprising at least one microwave depolymerization sensitizer compound, said method comprising the following steps:
placing the article in a reactor, and
subjecting the article placed in the reactor to microwave radiation at a frequency of between 10 MHz and 5.8 GHz, so as to initiate depolymerization by microwave absorption by said microwave sensitizer compound, and converting at least part of the article into at least one base monomer of said thermoplastic matrix.
